(19) United States
(12) Patent Application Publication
(10) Pub. No.: US 2011/0259079 A1
(43) Pub. Date: Oct. 27, 2011

(54) GAS SENSOR

(75) Inventors: Eriko Maeda, Okazaki-shi (JP); Takashi Sawada, Chiryu-shi (JP)

(73) Assignee: DENSO CORPORATION, Kariya-city (JP)

(21) Appl. No.: 13/094,036

(22) Filed: Apr. 26, 2011

(30) Foreign Application Priority Data
Apr. 26, 2010 (JP) 2010-100494

(51) Int. Cl. G01M 15/10

(52) U.S. Cl. 73/23.33

(57) ABSTRACT

A gas sensor is capable of detecting a concentration of PM contained in an exhaust gas emitted from a diesel engine. The gas sensor is comprised of a ceramic substrate and detection parts which are formed on the ceramic substrate with resistance parts. A resistance value of each of the resistance parts is changed on the basis of the quantity of conductive particulate matter captured by and accumulated on the detection parts. The detection parts have a different detection range. A part of the detection range of each of the detection parts is overlapped together. The concentration of PM contained in the target detection gas is detected on the basis of the change of the resistance value of the resistance parts.

### CROSS-REFERENCE TO RELATED APPLICATION

This application is related to and claims priority from Japanese Patent Application No. 2010-100494 filed on Apr. 26, 2010, the contents of which are hereby incorporated by reference.

### BACKGROUND OF THE INVENTION

1. Field of the Invention

The present invention relates to gas sensors capable of detecting conductive fine particles, for example, conductive particulate matter (PM), etc. contained in target detection gas such as exhaust gas emitted from internal combustion engines, thermal power stations equipped with steam turbines, etc.

2. Description of the Related Art

Recently, there has been proposed a system to combine a common rail fuel injection system, a super charger system, oxidizing catalyst, diesel particulate matter filter (DPF), a selective catalyst reduction (SCR) system, an exhaust gas recirculation (EGR) system, etc. in order to reduce environmental load substances such as nitrogen oxides NOx, particulate matter (PM), non-burned hydrogen carbon, etc. which are contained in exhaust gas emitted from diesel engines and lean-burn gasoline engines.

Such a DPF used in the above system has: (a1) a superior heat resistance; (a2) a honeycomb structure made of porous ceramic having a plurality of pores capable of capturing PM therein; and (a3) a regenerative function. In the regenerative operation, the DPF is heated in order to burn and eliminate PM captured in the pores. In general, a pressure loss of the DPF is increased when the pores are clogged by captured and accumulated PM. When the pressure loss of the DPF is increased, the regenerative of the DPF is executed by firing it with a burner, a heater, etc. or a post-injection control is executed in order to regenerate the DPF. In the post injection control, a small quantity of fuel is injected into cylinders of an internal combustion engine such as a diesel engine after combustion of the internal combustion engine.

In order to improve the efficiency of combustion of the internal combustion engine, it is requested for a gas sensor to continuously detect a concentration of PM contained in exhaust gas when an on-board diagnosis (OBD) is used in order (b1) to determine an optimum time when the DPF is to be generated; (b2) to detect the degree of deterioration of the DPF; and (b3) to detect occurrence of failure of the DPF and when a feedback control of an internal combustion engine is executed.

Still further, such a gas sensor applied to the above systems is requested to have a fail-safe function or a fail-secure function in order to correctly detect occurrence of a gas sensor failure. In addition, the regeneration control of a DPF requires in general detecting a pressure difference between an inlet side and an outlet side of the DPF in order to detect the degree of the clogged state of pores in the DPF. However, the clogged state of pores in the DPF is detected only when the DPF has a relatively large pressure loss.

For example, a conventional technique disclosed in Japanese patent laid open publication No. JP S59-197847 provides detection means for detecting PM contained in exhaust gas. In the conventional technique, a soot sensor which acts as the detection means is placed in an exhaust gas path through which an exhaust gas emitted from the internal combustion engine flows. An exhaust gas which contains soot flows through the gas flow path. The soot sensor detects the presence of soot contained in the exhaust gas. The soot sensor is comprised of a soot detection electrode and at least a pair of (or more pairs of) conductive electrodes. The soot detection electrode is composed of conductive porous material. The conductive electrodes detect an electric resistance of the soot detection electrode.

Further, another conventional technique disclosed in PCT International application publication NO. 2008/138661 provides a fine particle detection device comprised of at least a pair of (or more pairs of) electrodes formed on a substrate. The pair of the electrodes is covered with a conductive layer. A resistance value of the conductive layer is equal or smaller than a minimum resistance value of fine particles contained in a target detection gas.

Still further, another conventional technique disclosed in European patent application publication No. EP 1925926 provides a method of operating a sensor element in a gas sensor comprised of at least two electrodes and a substrate on which the electrodes are formed. A mixture of air and fuel as a target detection gas is exposed to the electrodes. The gas sensor detects fine particles contained in the mixture. The gas sensor detects the quantity of particles, in particular, carbon particles contained in the mixture. In particular, a conductive base is formed between the substrate and the electrodes. The electrodes are connected to the sensor element through a conductive paste. The sensor element detects the quantity of fine particles contained in the mixture of air and fuel.

In the conventional technique disclosed in the Japanese patent laid open publication No. JP S59-197847, the pair of the conductive electrodes in the soot detection sensor detects a change of electric resistance of the soot detection electrodes composed of conductive porous material on which soot is accumulated. Because the conventional technique detects the quantity of soot contained in a target detection gas on the basis of the detected electric resistance of the soot detection electrodes, it is possible to detect the presence of soot in a target detection gas even if a very small quantity of soot is accumulated on the soot detection electrodes. However, because the electric resistance of the soot detection electrodes is not changed when more quantity of soot is accumulated on the soot detection electrodes after the entire of the soot detection electrodes is covered with soot, the soot detection sensor as the conventional technique has a narrow detection range of detecting the quantity of soot. Further, there is a possibility for the soot detection sensor difficult to correctly detect abnormal state of the internal combustion engine when a large quantity of soot is rapidly accumulated on the soot detection electrodes.

Further, as disclosed in PCT International application publication NO. 2008/138661 and European patent application publication No. EP 1925926, when the electrodes in the detection sensor or the sensor element are electrically conducted through a conductive base layer which is formed on the bottom surfaces of the electrodes or with which the electrodes are covered, it is possible to eliminate a non-detectable period until the resistance formed by particles accumulated between the electrodes is detectable. However, this causes a drawback in which noises generated in the electrodes and the conductive layer is mixed with and superimposed on the detection signal. This decreases the detection accuracy of the detection sensor.

Still further, because the conductive layer in the conventional detection sensor is formed on the entire part of the electrodes on which particulate matter (PM) are accumulated, the change of resistance is small after a predetermined quantity of PM is accumulated on the electrodes. Accordingly, such conventional techniques have a drawback of it being difficult to correctly detect an abnormal state of a DPF such as occurrence of failure in the DPF occurs (for example, the DPF is damaged) and a relatively large quantity of soot is discharged from the DPF.

### SUMMARY OF THE INVENTION

It is an object of the present invention to provide a gas sensor with a simple configuration having a wide detection range capable of detecting a concentration of conductive particulate matter contained in a target detection gas.

To achieve the above purposes, the present invention provides a gas sensor capable of detecting a concentration of conductive fine particles such as particulate matter (PM) contained in a target detection gas by detecting a resistance value of detection parts. The resistance value of the detection parts is changed on the basis of the quantity of the conductive fine particles captured by and accumulated on the detection parts. The gas sensor has a heat resistance substrate and a plurality of detection parts. The detection parts are formed on a surface of the heat resistance substrate. The detection parts have a different detection range, respectively, and a part of which is overlapped together.

In particular, the heat resistance substrate indicates a substrate made of heat resistance material such as ceramic having a melting point of not less than 1000° C.

According to the gas sensor of the present invention, even if the gas sensor is in a non-detectable period in which a less quantity of conductive fine particles is accumulated on one of the detection parts and the resistance of the detection part is not changed, it is possible to detect the concentration of conductive fine particles such as particulate matter contained in a target detection gas by using another detection part having a different detection range. This makes it possible to provide the gas sensor with a wide detection range capable of detecting the concentration of conductive fine particles contained in the target detection gas.

In the gas sensor as another aspect of the present invention, the detection parts are composed of a first detection part and a second detection part. A detection range of the second detection part is within a range of 1/10 to ½ times of a detection range of the first detection part.

This makes it possible for the second detection part to execute the detection during the non-detectable period of the first detection part, and therefore possible to provide the gas sensor capable of detecting a concentration of conductive fine particles contained in a target detection gas with a long detection range.

In addition, because the configuration of the gas sensor according to the present invention makes it possible to have a simultaneous output period in which the first detection part and the second detection part simultaneously output the detection voltages, it is possible for one detection part to detect abnormal state of another detection part on the basis of a difference between the time when the output voltage of the second detection part is saturated and the period of time when the output voltage of the first detection part becomes detectable.

In the gas sensor as another aspect of the present invention, the first detection part is comprised of one or more pairs of detection electrodes formed on the heat resistance substrate. The detection electrodes in each pair face to each other and are arranged at a first gap. The second detection part is comprised of one or more pairs of detection electrodes formed on the heat resistance substrate. The detection electrodes in each pair face to each other and are arranged at a second gap within a range of 1/10 to 1.2 times of the first gap.

According to the present invention, it is possible to optionally adjust the detection range of the second detection part within the range of 1/10 to 1.2 times of the detection range of the first detection part. This makes it possible for the gas sensor to easily obtain a wide detection range.

In the gas sensor as another aspect of the present invention, at least the second detection part is comprised of the detection electrodes and a porous conductive layer having a predetermined porosity formed on the heat resistance substrate.

According to the present invention, it is possible for the gas sensor to avoid a non-detectable period from being generated therein because a small current flows in the second detection part even if no conductive fine particle such as PM is accumulated on the second detection part and the first detection part. This makes it possible for the gas sensor to output the detection voltage to an external device. Still further, it is possible to adjust the optimum detection range of the gas sensor by adjusting the porosity of the porous conductive layer.

In the gas sensor as another aspect of the present invention, the first detection part and the second detection part are placed at an upper side and a bottom side of the gas sensor along a longitudinal direction of the gas sensor so that the second detection part is arranged at a high temperature side when the gas sensor is placed in a target detection gas to be detected.

According to the present invention, it is possible to selectively detect conductive fine particles such as PM, contained in the target detection gas captured by and accumulated on the second detection part, on the basis of its particle size.

In the gas sensor as another aspect of the present invention, the gas sensor detects a concentration of a target detection gas emitted from an internal combustion engine such as a diesel engine, a gasoline engine and a gasoline direct injection engine. The target detection gas flows in the exhaust gas system of the internal combustion engine.

According to the present invention, it is possible to apply the gas sensor to exhaust gas purifying systems for internal combustion engines such as diesel engines and large scaled plants such as thermal power stations, and to execute fault diagnosis of the exhaust gas purifying systems with high accuracy.

### BRIEF DESCRIPTION OF THE DRAWINGS

A preferred, non-limiting embodiment of the present invention will be described by way of example with reference to the accompanying drawings, in which:

FIG. 1 is a plan view of a schematic configuration of a gas sensor according to a first embodiment of the present invention;

FIG. 2A is a view showing an equivalent circuit of the gas sensor according to the first embodiment shown in FIG. 1;

FIG. 2B is a view showing an example of a detection range of the first detection part and a detection range of the second detection part in the gas sensor according to the first embodiment, where the output of the gas sensor corresponds to the quantity of PM accumulated on the first detection part and the second detection part in the gas sensor;

FIG. 3A is a view showing output characteristics of the gas sensor according to the first embodiment when a DPF is working correctly;

FIG. 3B is a view showing output characteristics of the gas sensor according to the first embodiment when the DPF is damaged;

FIG. 3C is a view showing output characteristics of the gas sensor according to the first embodiment when PM is accumulated in the DPF;

FIG. 4A is a view showing output characteristics of the gas sensor according to the first embodiment when wire damage occurs in a second detection part of the gas sensor;

FIG. 4B is a view showing output characteristics of the gas sensor according to the first embodiment when wire deterioration is generated in the second detection part of the gas sensor;

FIG. 5A is a view showing output characteristics of the gas sensor according to the first embodiment when wire damage occurs in a first detection part of the gas sensor;

FIG. 5B is a view showing output characteristics of the gas sensor according to the first embodiment when wire deterioration occurs in the first detection part of the gas sensor;

FIG. 6A is a view showing a partial cross section of a gas sensor according to a second embodiment of the present invention;

FIG. 6B is a view showing a cross section along the A-A line shown in FIG. 6A;

FIG. 6C is a view showing output characteristics of the gas sensor according to the second embodiment when PM is accumulated on the second detection part in the gas sensor;

FIG. 7A is a plan view showing a schematic configuration of detection parts in a gas sensor according to a third embodiment of the present invention;

FIG. 7B is a plan view showing a schematic configuration of a detection part in a gas sensor according to a fourth embodiment of the present invention;

FIG. 8A is a plan view showing detection parts in a gas sensor according to a fifth embodiment of the present invention;

FIG. 8B is a view showing a partial development of one of the detection parts in the gas sensor according to the fifth embodiment of the present invention; and

FIG. 9A and FIG. 9B are views, each showing an equivalent circuit of a modification of the gas sensor according to the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

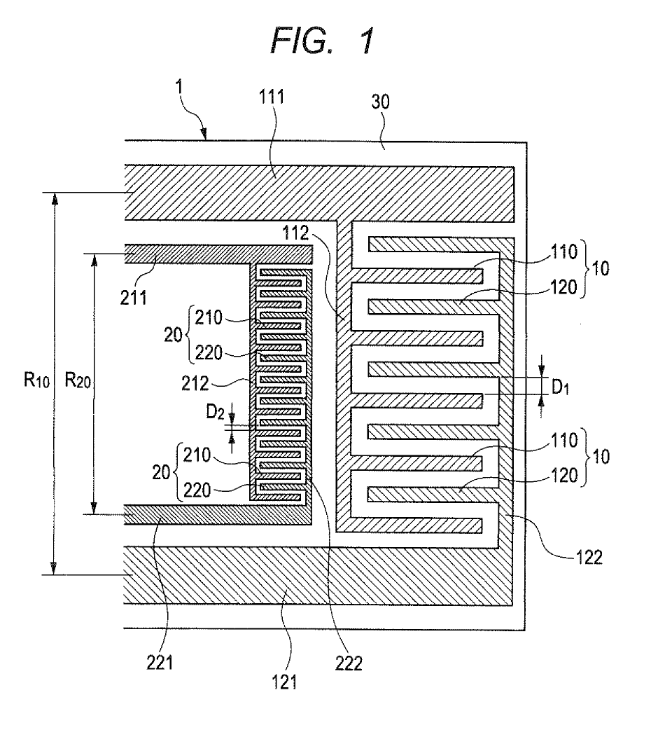

A description will be given of a gas sensor according to a first embodiment of the present invention with reference to FIG. 1 to FIG. 5A and FIG. 5B.

FIG. 1 is a plan view of a schematic configuration of the gas sensor 1 according to the first embodiment of the present invention. The gas sensor 1 according to the first embodiment detects a concentration of fine particles, in particular conductive fine particles such as particulate matter PM contained in exhaust gas emitted from an internal combustion engine such as a diesel engine. In order to execute on-board diagnosis for detecting occurrence of failure in a diesel particulate filter (DPF) and regeneration of the DPF, the gas sensor 1 detects the concentration of PM contained in the exhaust gas. In general, the DPF captures particulate matters PM contained in the exhaust gas emitted from an internal combustion engine such as a diesel engine.

The gas sensor 1 is formed by using a known technique such as a thick film substrate printing and a photolithography in which a first detection part 10 and a second detection part 20 made of conductive material are formed on a surface of a heat-resistant substrate such as a ceramic substrate 30. The ceramic substrate 30 approximately has a plate shape and a melting point of not less than 100° C.

It is acceptable for the ceramic substrate 30 as the heat-resistant substrate to be made of another anti-thermal material such as macromolecular substance and heat-resistant glass other than ceramic.

The first detection part 10 is comprised of at least a pair of (or more pairs of) detection electrodes 110 and 120 which face to each other and are arranged at a first gap D1. The second detection part 20 is composed of at least a pair of (or more pairs of) detection electrodes 210 and 220 which face to each other and are arranged at a second gap D2. In particular, the second gap D2 is within a range of 1/10 to ½ times of the first gap D1.

In the gas sensor 1 according to the first embodiment shown in FIG. 1, the first detection part 10 is comprised of one or more pairs of pairs of detection electrodes 110 and 120. The detection electrodes 110 and the detection electrodes 120 have a comb structure so that the detection electrodes 110 face the detection electrodes 120 to each other, and the detection electrodes 110 and the detection electrodes 110 are alternately arranged in the comb structure. The detection electrodes 110 and 120 are placed in a space formed between a pair of lead parts 111 and 121 so that the detection electrodes 110 and 120 extend in a direction at a right angle from lead parts 112 and 122. The lead parts 112 and 122 extend in a direction at a right angle from the lead parts 111 and 121. The first gap D1 is formed between the adjacent detection electrodes 110 and 120.

On the other hand, the second detection part 20 is comprised of one or more pairs of detection electrodes 210 and 220. The detection electrodes 210 and the detection electrodes 220 have a comb structure so that the detection electrodes 210 face the detection electrodes 220 to each other, and the detection electrodes 210 and the detection electrodes 210 are alternately arranged in the comb structure. The detection electrodes 210 and 220 are placed in a space formed between a pair of lead parts 211 and 221 so that the detection electrodes 210 and 220 extend in a direction at a right angle from lead parts 212 and 222. The lead parts 212 and 222 extend in a direction at a right angle from the lead parts 211 and 221. The second gap D2 is formed between the adjacent detection electrodes 210 and 220.

The first detection part 10 and the second detection part 20 in the gas sensor 1 according to the first embodiment are exposed to a target detection gas such as an exhaust gas containing conductive fine particles such as particulate matters PM emitted form an internal combustion engine such as a diesel engine. The first detection part 10 and the second detection part 20 capture PM. The PM is accumulated on the surface of the first detection part 10 and the second detection part 20. A first resistance value R10 of the first detection part 10 and a second resistance value R20 of the second detection part 20 are changed according to the amount of the accumulated PM. An external device (not shown) detects a first resistance value R10 of the first detection part 10 and a second resistance value R20 of the second detection part 20. A concentration of PM contained in the target detection gas is detected on the basis of the first resistance value R10 and the second resistance value R20 detected by the external device.

A heat unit is laminated on the back surface of the ceramic substrate 30 or a heat unit is formed in the inside of the ceramic substrate 30 by a widely-known conventional technique. When receiving electric power, the heat unit generates heat energy in order to eliminate PM accumulated on the first detection part 10 and the second detection part 20.

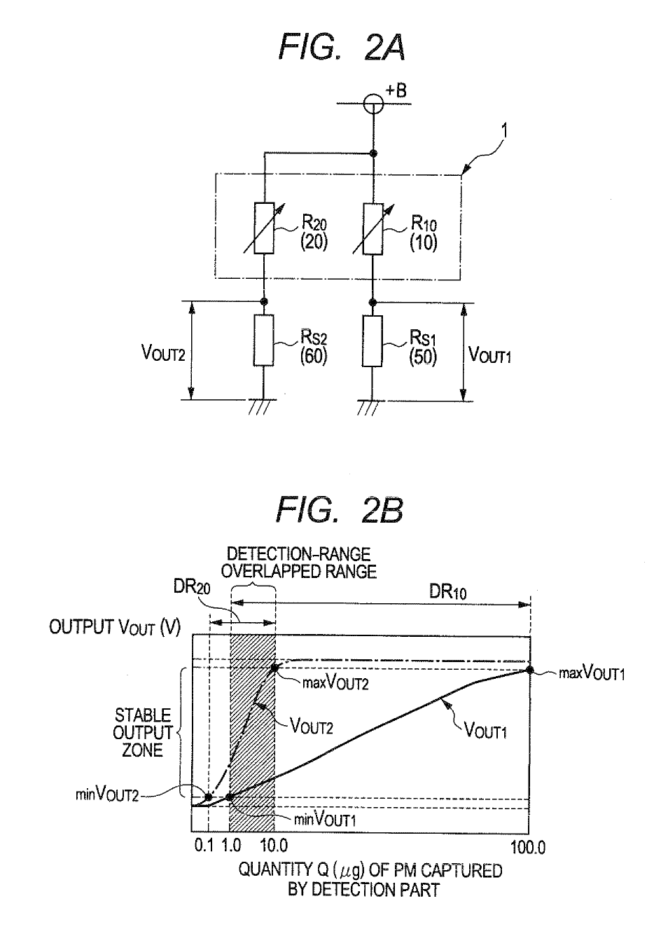

A description will now be given of the effects of the gas sensor 1 according to the first embodiment with reference FIG. 2A and FIG. 2B.

FIG. 2A is a view showing an equivalent circuit of the gas sensor 1 according to the first embodiment shown in FIG. 1.

The output of the gas sensor 1 corresponds to the quantity of PM accumulated on the first detection part 10 and the second detection part 20 in the gas sensor 1.

As shown in FIG. 2A, it is possible to detect the first resistance value R10 of the first detection part 10 on the basis of a first output voltage Vout1 of a voltage dividing resistance (Rs1) 50. The voltage of the electric power source (+B) is divided by the voltage dividing resistance (Rs1) 50 and the first resistance value R10 of the first detection part 10. Further, it is possible to detect the second resistance value R20 of the second detection part 20 on the basis of a second output voltage Vout2 of a voltage dividing resistance (Rs2) 60. The voltage of the electric power source (+B) is divided by the voltage dividing resistance (Rs2) 60 and the second resistance value R20 of the second detection part 20.

FIG. 2B is a view showing an example of a detection range of the first detection part 10 and a detection range of the second detection part 20 in the gas sensor 1 according to the first embodiment.

For example, the first detection part 10 is formed so that the first output voltage Vout1 becomes a minimum detectable voltage minVout1 (for example, 0.1 V) when the quantity Q of PM captured by and accumulated on the first detection part 10 reaches 1.0 μg, and the first output voltage Vout1 becomes a maximum voltage maxVout1 (for example, 9.9 V) when the quantity Q of PM captured by and accumulated on the first detection part 10 reaches 100.0 μg.

On the other hand, the second detection part 20 is formed so that the second output voltage Vout2 becomes a minimum detectable voltage minVout2 (for example, 0.1 V which is equal to the minimum detectable voltage minVout1) when the quantity Q of PM captured by and accumulated on the second detection part 20 reaches 0.1 μg, and the second output voltage Vout2 becomes a maximum voltage maxVout2 (for example, 9.9 V which is equal to the maximum voltage maxVout 1) when the quantity Q of PM captured by and accumulated on the second detection part 20 reaches 10.0 μg.

Accordingly, the detection range DR10 of the first detection part 10 in the gas sensor 1 is from 1.0 μg to 100.0 μg. The detection range DR20 of the second detection part 20 in the gas sensor 1 is from 0.1 μg to 10.0 μg. Thus, the detection range DR10 of the first detection part 10 and the detection range DR20 of the second detection range 20 are overlapped in the range of 1.0 μg to 10.0 μg.

In the configuration of the gas sensor 1 according to the first embodiment, it is possible to change the second gap D2 between the adjacent detection electrodes 210 and 220 in the second detection part 20 within a range of 1/10 to ½ times of the first gap D1 between the adjacent detection electrodes 110 and 120 in the first detection part 10 in order to overlap a part of the detection range DR10 of the first detection part 10 with a part of the detection range DR20 of the second detection part 20.

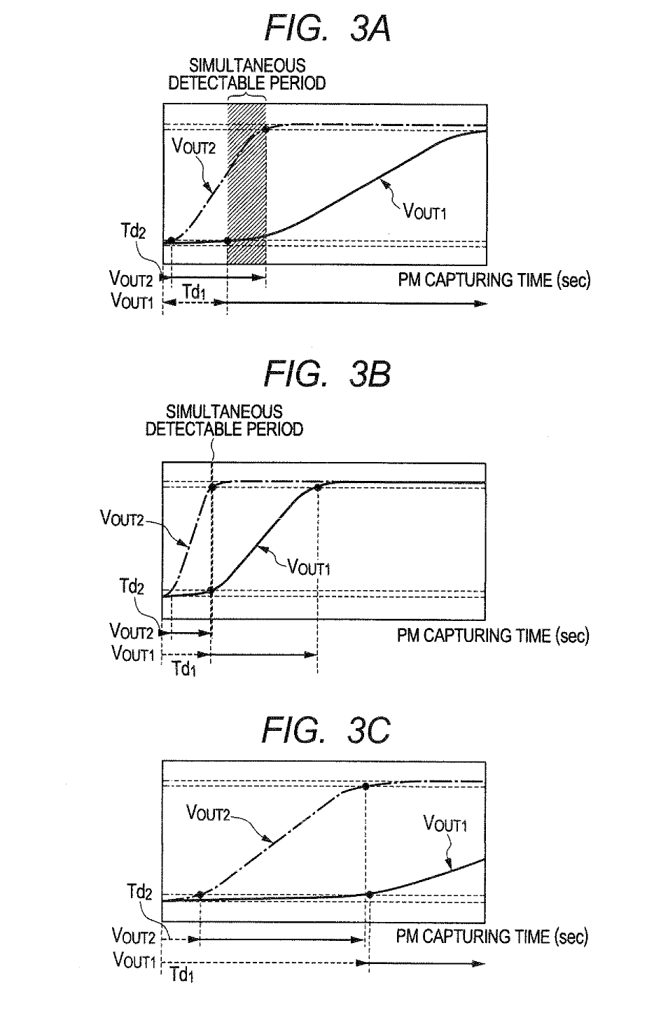

A description will now be given of the effects of the gas sensor 1 according to the first embodiment with reference to FIG. 3A to FIG. 3C.

FIG. 3A is a view showing output characteristics of the gas sensor 1 according to the first embodiment when a DPF is working correctly. FIG. 3B is a view showing output characteristics of the gas sensor 1 according to the first embodiment when the DPF is damaged.

As shown in FIG. 3A, when the gas sensor 1 has the configuration in which the first detection part 10 and the second detection part 20 are formed on the ceramic substrate 30 while satisfying the above relationship regarding the detection range DR10 and the detection range DR20, the first gap D1 and the second gap D2, PM contained in a target detection gas is accumulated on the first detection part 10, and a conductive path is formed by the accumulated PM between the detection electrode 110 and the detection electrode 120, and the first detection resistance value R10 is gradually decreased. When the quantity of PM is accumulated on the second detection part 20, which becomes a range of 1/10 to ½ times of the quantity of PM which is detectable by using the first resistance value R10, the second detection resistance R20 formed by the PM accumulated on the second detection part 20 becomes detectable, and the second output Vout2 is thereby increased.

This makes it possible for the second detection part 20 to correctly detect PM accumulated on the first detection part 10 and the second detection part 20 even if the accumulated PM has a less quantity and the first detection part 10 does not provide the first output Vout1 to the external device (not shown). This eliminates the non-detectable period Td1.

Although there is another non-detectable period Td2 in which the second detection part 20 cannot detect accumulated PM, because the non-detectable period Td2 is a very short period of time, it is possible to ignore this non-detectable period Td2.

When the first resistance value R10 generated by PM accumulated on the first detection part 10 is further decreased and the first output voltage Vout1 is not less than the minimum detectable voltage minVout1, the first output voltage Vout1 is gradually increased, and the gas sensor 1 outputs both the first output voltage Vout1 and the second output voltage Vout2 until the quantity of PM accumulated on the second detection part 20 is saturated and the second output voltage Vout2 of the second detection part 20 exceeds the maximum detectable voltage maxVout1. After this, the first output voltage Vout1 is saturated, and the first output voltage Vout1 is increased only until the first output voltage Vout1 reaches the maximum detectable voltage maxVout1.

As shown in FIG. 3A, because the gas sensor 1 according to the first embodiment has the detection period of time during which the first output voltage Vout1 and the second output voltage Vout2 simultaneously output the first output voltage Vout1 and the second output voltage Vout2, respectively, it is possible for the gas sensor 1 to be used as OBD (on-board diagnosis) capable of detecting occurrence of abnormal condition of a DPF such as a defect of the DPF and the clogged state of the DPF in which pores are clogged by PM which is captured by detecting the presence of the first output voltage Vout1 and the second output voltage Vout2.

A description will now be given of the operation and effects of the gas sensor 1 according to the first embodiment when introducing a target detection gas which contains a large quantity of PM in a short period of time caused by damage to a DPF.

When the gas sensor 1 receives a large quantity of PM in a short period of time, the first output voltage Vout1 and the second output voltage Vout2 have a fast rising speed. The output voltage of the second detection part 20 is rapidly saturated because it has a narrow detectable range. On the other hand, because the first detection part 10 has a wide detectable range, first output voltage Vout1 of the first detection part 10 is gradually increased when compared with the case of the second detection part 20.

As shown in FIG. 3B, because the simultaneous detectable period for simultaneously detecting both the first output voltage Vout1 and the second output voltage Vout2 becomes a very short period of time, it is possible for an external device (not shown) to detect a large quantity of PM contained in a target detection gas caused by damage to a DPF on the basis of a comparison result in a rising timing between the first output voltage Vout1 and the second output voltage Vout2 and the comparison result in a rising time between the first output voltage Vout1, the second output voltage Vout2, and a predetermined threshold time. When the detection result indicates an occurrence of damage to the DPF, it is possible for the external device to provide warning to an operator.

A description will now be given of a case when pores in a DPF are clogged by accumulated PM with reference to FIG. 3C.

FIG. 3C is a view showing output characteristics of the gas sensor 1 according to the first embodiment when PM is accumulated in the DPF and pores in the DPF are clogged.

Because the quantity of PM supplied to the first detection part 10 and the second detection part 20 is decreased when PM is accumulated in the DPF, and it is required to regenerate the DPF, the first output voltage Vout1 and the second output voltage Vout2 are gradually changed, as shown in FIG. 3C.

In particular, when a less quantity of PM is supplied to the first detection part 10, the non-detectable period Td1 of the first detection part 10 becomes long. Because the detectable range of the second detection part 20 has a range of 1/10 to ½ times of the detectable range of the first detection part 10, the non-detectable period Td1 of the first detection part 10 becomes long, and there is a possibility for the second detection part 20 to be saturated before the first detection part 10 reaches a detectable condition.

In this case, the external device detects that the DPF enters the clogged state in which pores are clogged by accumulated PM, and provides a request for regenerating the DPF or warning to the operator.

As described above in detail, because the gas sensor 1 according to the first embodiment has the first detection part 10 and the second detection part 20, it is possible to detect occurrence of abnormal state of the DPF on the basis of a difference in rising between the first output voltage Vout1 and the second output voltage Vout2.

A description will now be given of the effects of the gas sensor 1 according to the first embodiment when an abnormal state of each of the first detection part 10 and the second detection part 20 is detected by using the first detection part 10 and the second detection part 20.

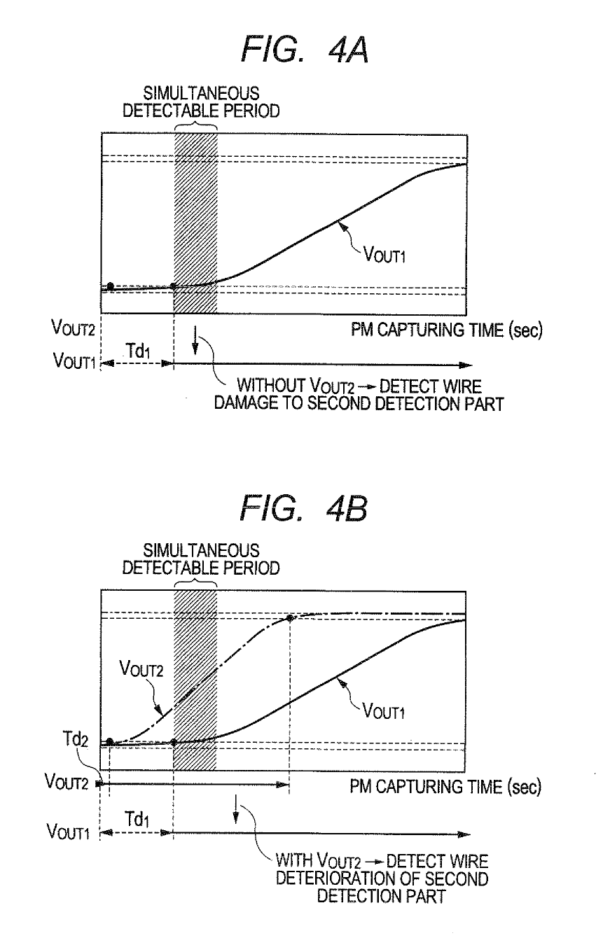

FIG. 4A is a view showing output characteristics of the gas sensor 1 according to the first embodiment when wire damage occurs in the second detection part 20 in the gas sensor. FIG. 4B is a view showing output characteristics of the gas sensor 1 according to the first embodiment when wire deterioration occurs in the second detection part 20 in the gas sensor 1.

As shown in FIG. 4A, when wire damage occurs in the second detection part 20 of the gas sensor 1, the external device (not shown) cannot detect the second output voltage Vout2 during the simultaneous detectable period, and on the other hand can detect the first output voltage Vout1 only. Accordingly, the external device (not shown) detects and judges the occurrence of wire damage in the second detection part 20 in the gas sensor 1, and provides to the operator a warning of the abnormal state of the gas sensor 1.

Further, as shown in FIG. 4B, when wire deterioration occurs in the second detection part 20 in the gas sensor 1, the second output voltage Vout2 is slowly risen (or the rising speed of the second output voltage Vout2 is decreased), nevertheless a large quantity of PM is accumulated on the second detection part 20 so that the output voltage Vout2 of the second detection part 20 is saturated. As a result, in this case, the simultaneous detectable period of time in which the first output voltage Vout1 and the second output voltage Vout2 are simultaneously detectable becomes long.

Accordingly, when the external device (not shown) detects the first output voltage Vout1 and the second output voltage Vout2 during a long period of time which exceeds the detectable period of time in the normal condition, the external device can judge the occurrence of wire deterioration in the second detection part 20. The external device provides to the operator a warning regarding the occurrence of abnormal state in the gas sensor 1.

It is also possible for the external device to detect the abnormal condition of the gas sensor 1 by detecting a slope of change of the first output voltage Vout1 and the second output voltage Vout2.

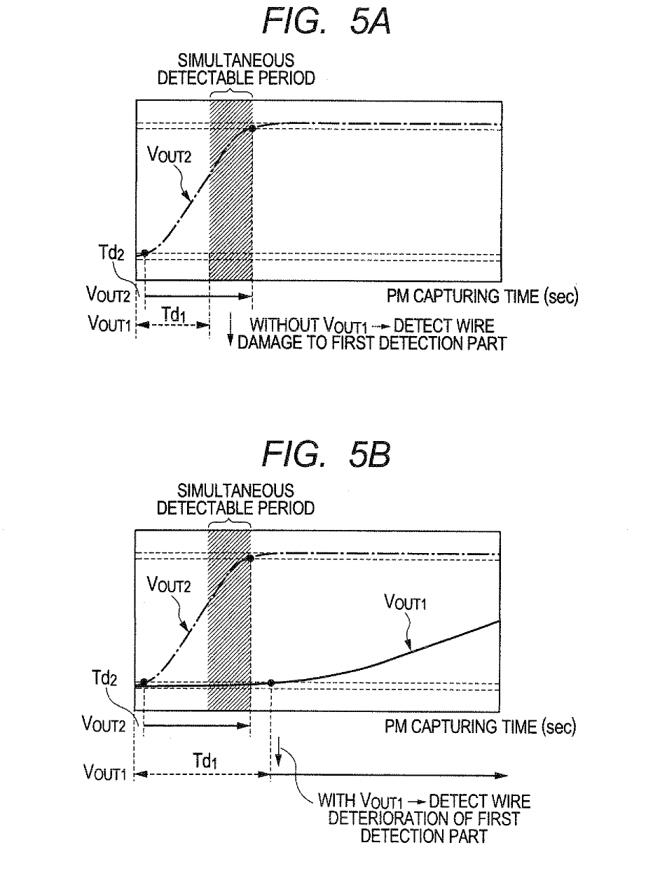

FIG. 5A is a view showing output characteristics of the gas sensor 1 according to the first embodiment when wire damage occurs in the first detection part 10 of the gas sensor 1. FIG. 5B is a view showing output characteristics of the gas sensor 1 according to the first embodiment when wire deterioration occurs in the first detection part 10 of the gas sensor 1.

As shown in FIG. 5A, when wire damage occurs in the first detection part 10 of the gas sensor 1, the external device (not shown) cannot detect the first output voltage Vout1 during the simultaneous detectable period. The second output voltage Vout2 is thereby saturated.

Accordingly, the external device (not shown) detects and judges the occurrence of wire damage in the first detection part 10 in the gas sensor 1, and provides to the operator a warning of the abnormal state of the gas sensor 1.

Further, as shown in FIG. 5B, when wire deterioration occurs in the first detection part 10 in the gas sensor 1, the first output voltage Vout1 is slowly risen, and a detectable period of time in which the first output voltage Vout1 and the second output voltage Vout2 are simultaneously detectable becomes long, nevertheless a large quantity of PM is accumulated on the second detection part 20 so that the output voltage Vout2 of the second detection part 20 is saturated. As a result, the detectable period of time in which the first output voltage Vout1 and the second output voltage Vout2 are simultaneously detectable becomes long.

Accordingly, when the external device (not shown) cannot detect both the first output voltage Vout1 and the second output voltage Vout2 during the simultaneous detectable period of time in the normal condition, the external device can judge that wire deterioration has occurred in the first detection part 10. The external device provides to the operator a warning regarding the occurrence of abnormal state in the gas sensor 1.

In the gas sensor 1 according to the first embodiment previously described, the first output voltage Vout1 of the first detection part 10 and the second output voltage Vout2 of the second detection part 20 are detected by using the voltage dividing resistances (Rs1) 50 and the voltage dividing resistance (Rs2) 60, respectively. However, the present invention is not limited by this. For example, it is possible for the gas sensor 1 to have another configuration for detecting the voltage of the first resistance R10 in the first detection part 10 and the voltage of the second resistance R20 in the second detection part 20 by using a single detection means. The first resistance R10 generated in the first detection part 10 and the second resistance R20 generated in the second detection part 20 are detected by the single detection means by switching the detection target from the second resistance R20 to the first resistance R10 when the output voltage Vout2 is saturated.

In this case, the external device (not shown) detects a switching time of the second output voltage Vout2 and the first output voltage Vout1, and judges the occurrence of damage to the DPF when the detected switching time is faster than the simultaneous detectable period of time, and judges the occurrence of the clogged state of the DPF when the detected switching time is later than the simultaneous detectable period of time.

### Second Embodiment

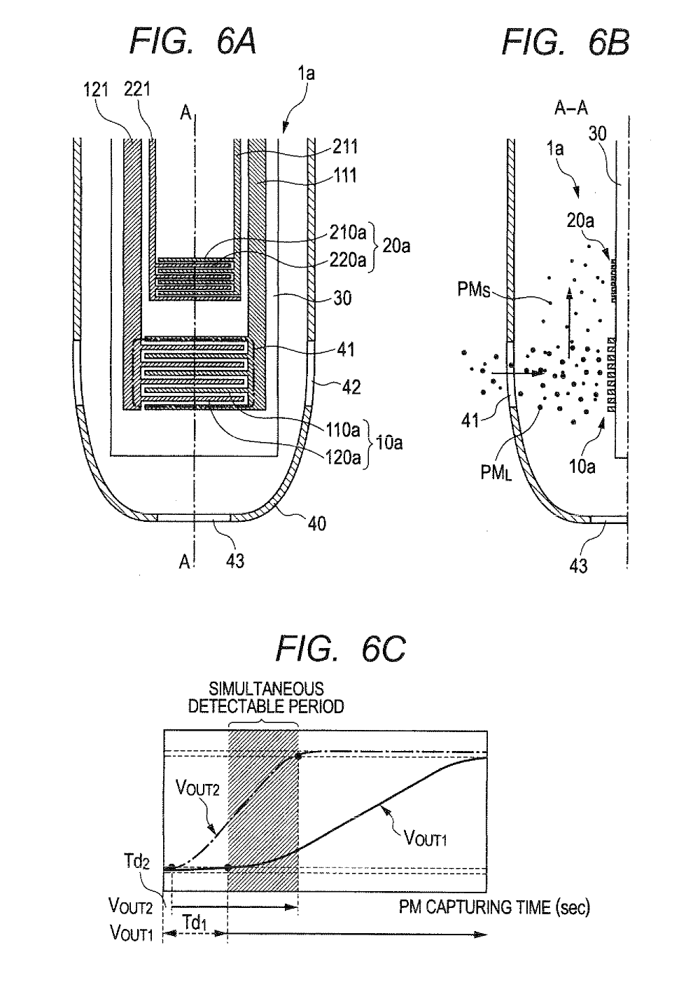

A description will be given of the gas sensor according to the second embodiment of the present invention with reference to FIG. 6A, FIG. 6B, and FIG. 6C.

FIG. 6A is a view showing a partial cross section of the gas sensor 1a according to the second embodiment of the present invention.

A pair of first detection electrodes 110a and 120a and a pair of second detection electrodes 210a and 220a are formed on the ceramic substrate 30 in the gas sensor 1a so that the detection range of the second detection part 20a is within a range of 1/10 to ½ times of the first detection range 10a.

Further, as shown in FIG. 6A, in the configuration of the gas sensor 1a according to the second embodiment, the first detection part 10a and the second detection part 20a are arranged so that the second detection part 20a is arranged at a higher temperature side than the first detection part 10a along the direction of the longitudinal of the ceramic substrate 30. The gas sensor 1a is covered with a cover body 40. An inlet hole 41 formed in the cover body 40 faces the first detection part 10a. Through the inlet hole 41, a target detection gas is introduced into the inside of the gas sensor 1a.

As shown in FIG. 6A, the cover body 40 has approximately a cylindrical shape having a bottom part (or a closed base). A plurality of the inlet hole 41 and inlet holes 42 and 43 is formed in the side surface and the bottom surface of the cover body 40.

FIG. 6B is a view showing a cross section along the A-A line shown in FIG. 6A.

As shown in FIG. 6B, a target detection gas containing conductive particulate matter PM is introduced into the inside of the cover body 40 through the inlet hole 41. The target detection gas collides with the surface of the first detection part 10a. At this time, particulate matter PM_{L} having a relatively large particle size of not less than φ10 μm in the target detection gas is captured by and accumulated on the first detection part 10a.

On the other hand, particulate matter PMₛ having a relatively small particle size of less than φ10 μm in the target detection gas rides an up-current of gas generated by a temperature distribution in the inside of the cover body 40 in which the target detection gas has a reduced flow speed. The particulate matter PM_{S} having a relatively small particle size of less than φ10 μm is captured by and accumulated on the second detection part 20a which is arranged at a upper side of the first detection part 10a.

The second embodiment shows the configuration of the gas sensor 1a in which comb-shaped electrodes which form the first detection part 10a and the second detection part 20a are arranged at a right angle of the longitudinal direction of the ceramic substrate 30. However, the concept of the present invention is not limited by this configuration. For example, it is possible for the first detection part 10a and the second detection part 20a to be arranged in parallel to the longitudinal direction of the ceramic substrate 30a, like the configuration of the gas sensor 1 according to the first embodiment.

FIG. 6C is a view showing output characteristics of the gas sensor 1a according to the second embodiment when particulate matter PM is accumulated on the second detection part 20a in the gas sensor 1a.

According to the configuration of the gas sensor 1a according to the second embodiment, because small sized particles such as particulate matter PM_{S} having a relatively small particle size of less than φ10 μm are accumulated on the second detection part 20a, The second output voltage Vout2 has a slow rising speed. This makes it possible for the gas sensor 1a to have a long simultaneous detectable period of time in which external device (not shown) can simultaneously detect both the first output voltage Vout1 and the second output voltage Vout2 when compared with the simultaneous detectable period of time in the gas sensor 1 according to the first embodiment.

Further, it is possible for the gas sensor 1a according to the second embodiment to execute the operation for detecting occurrence of abnormal state in a DPF by using a plurality of detailed detection patterns which shows detailed abnormal-occurrence conditions because the first detection part 10a and the second detection part 20a detect different particle size groups of PM, respectively.

### Third Embodiment

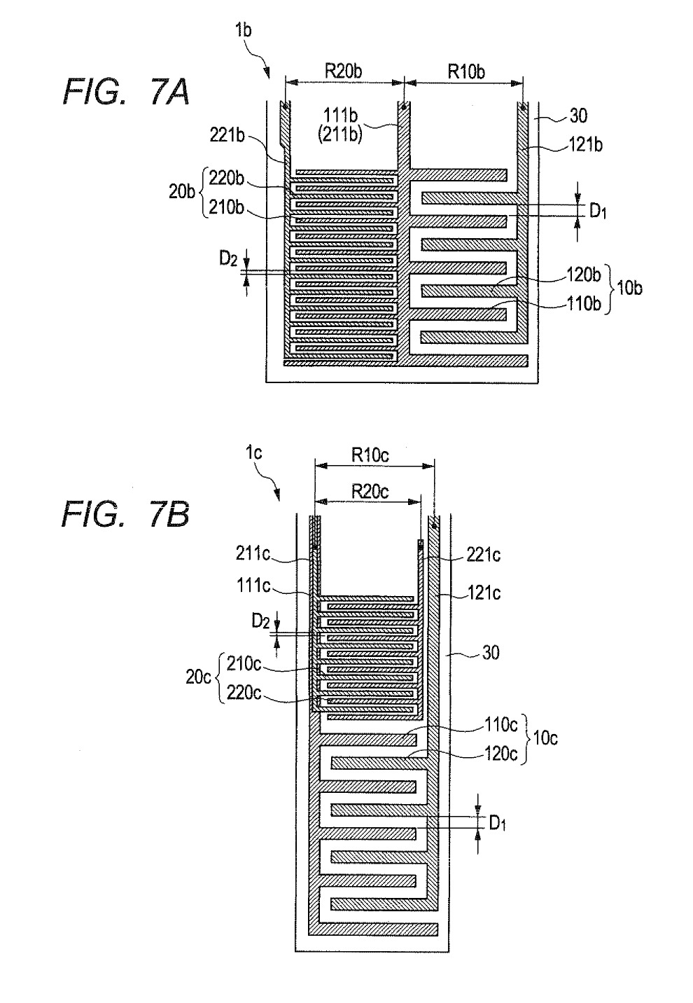

A description will be given of the gas sensor according to the third embodiment of the present invention with reference to FIG. 7A.

FIG. 7A is a plan view showing a schematic configuration of a detection part in a gas sensor 1b according to a third embodiment of the present invention.

The first and second embodiments previously described show the configuration of the gas sensor 1 and 1a in which the first detection part 10, 10a and the second detection part 20, 20a are arranged at upper and bottom sides along the longitudinal direction of the ceramic substrate 30.

As shown in FIG. 7A, in the configuration of the gas sensor 1b according to the third embodiment, a first detection part 10b and a second detection part 20b are arranged in parallel at right and left sides along the longitudinal direction of the ceramic substrate 30.

As shown in FIG. 7A, it is further possible for the gas sensor 1b to have the configuration in which the lead part 111b of the first detection part 10b and the lead part 211b of the second detection part 20b are formed by the single lead part 111b (211b).

### Fourth Embodiment

A description will be given of a gas sensor 1c according to the fourth embodiment of the present invention with reference to FIG. 7B.

FIG. 7B is a plan view showing a schematic configuration of the detection parts in the gas sensor 1c according to the fourth embodiment of the present invention.

As shown in FIG. 7B, it is possible for the gas sensor 1e to have a configuration in which the first detection part 10c and the second detection part 20c are arranged at upper and bottom sides along the longitudinal direction of the ceramic substrate 30, and the lead part 111c of the first detection part 10c and the lead part 221c of the second detection part 20c are formed by a single lead part.

### Fifth Embodiment

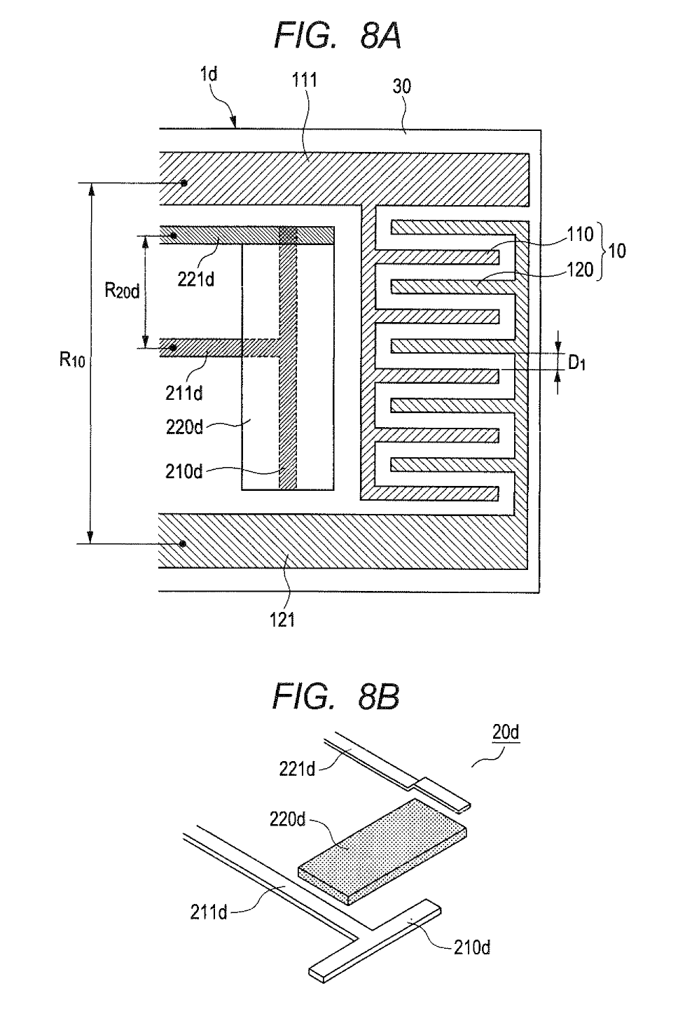

A description will be given of a gas sensor 1d according to the fourth embodiment of the present invention with reference to FIG. 8A and FIG. 8B.

FIG. 8A is a plan view showing detection parts in the gas sensor 1d according to the fifth embodiment of the present invention. FIG. 8B is a view showing a partial development of one of the detection parts in the gas sensor 1d according to the fifth embodiment of the present invention.

In the first to fourth embodiments previously described, each of the first detection part and the second detection part is comprised of a pair of the comb-shaped electrodes, and the detection range of the electrodes is changed by adjusting the gaps D1 and D2 between the adjacent electrodes.

On the other hand, in the configuration of the gas sensor 1d according to the fifth embodiment shown in FIG. 8A and FIG. 8B, the second detection part 20d is comprised of an electrode 210d, a porous conductive layer 220d, and lead parts 211d and 221d.

As shown in FIG. 8B, the porous conductive layer 220d in the second detection part 20d is made of a porous semiconductor film having a predetermined porosity and formed between adjacent detection electrodes 110d and 210d so that a resistance value of the second detection part 20d has a range of 100 kΩ to 100 MΩ.

Further, it is possible for the first detection part 10d to have a porous conductive layer 110d so that a resistance value of the first detection part 10d has a range of 100 kΩ to 100 MΩ

The resistance value of each of the first detection part 10d and the second detection part 20d is changed by adjusting the porosity of the porous conductive layer. When each of the first detection part and the second detection part in the gas sensor is composed of comb-shaped electrodes, a small quantity of particulate matter PM is accumulated on the gap between the adjacent comb-shaped electrodes. Accordingly, it is not to output the first output voltage Vout1 and the second output voltage Vout2 until a conductive path is formed on the gap between the adjacent detection electrodes.

On the other hand, according to the configuration of the gas sensor 1d shown in FIG. 8A and FIG. 8B, it is possible to continuously output the first output voltage Youth and the second output voltage Vout2 even if a small quantity of particulate matter PM is accumulated on the first detection part 10d and the second detection part 20d. This indicates that a small current flows in the porous semiconductor film which forms the second detection part 20d even if no particulate matter PM is accumulated on the first detection part 10d and the second detection part 20d.

### (Modifications)

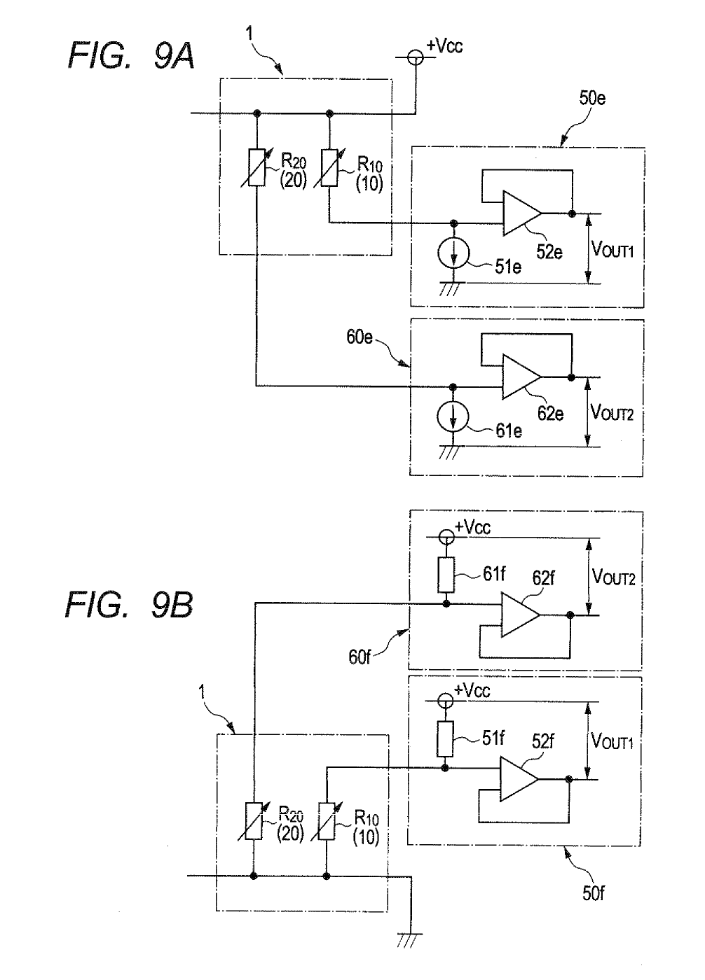

A description will now be given of a modification of the gas sensor according to the present invention with reference to FIG. 9A and FIG. 9B.

FIG. 9A and FIG. 9B are views, each showing an equivalent circuit of a modification of the gas sensor according to the present invention.

In particular, the gas sensor according to a modification is comprised of a first resistance detection means 50 and a second resistance detection means 60. In the first to fifth embodiments previously described, for example, as shown in FIG. 2A, the voltage (+B) of an electric power source is divided by the first detection resistance R10 and the voltage dividing resistance Rs1 in order to detect the first output voltage Vout1. Similarly, the voltage (+B) of the electric power source is divided by the second detection resistance R20 and the voltage dividing resistance Rs2 in order to detect the second output voltage Vout2.

However, the concept of the present invention is not limited by the configuration. For example, it is possible for the gas sensor according to the present invention to have a configuration shown in FIG. 9A. As shown in FIG. 9A, a first constant current power source 51e is used as a first resistance detection means 50e, a first operational amplifier 52e detects the first output voltage Vout1. Similarly, a second constant current power source 61e is used as a second resistance detection means 60e, a second operational amplifier 62e detects the second output voltage Vout2.

Further, as shown in FIG. 9B, it is possible for the gas sensor according to the present invention to have a configuration in which a first voltage dividing resistance 51f and a first operational amplifier 52f are placed at an upstream side of the first detection resistance R10 in order to detect the first output voltage Vout1, and similarly, a second voltage dividing resistance 61f and a second operational amplifier 62f are placed at the upstream side of the second detection resistance R10 in order to detect the second output voltage Vout2.

Still further, it is also possible to form the gas sensor by combining the configurations of the first to fifth embodiments and the above modifications.

The concept of the present invention is not limited by the embodiments previously described. It is possible to modify the configuration of the gas sensor so that the gas sensor has a plurality of detection parts having a different detection range, a part of the detection range of each of which is overlapped together in order to eliminate the non-detectable period of time, and an on-board diagnosis (OBD) is used the overlapped detection range. For example, the gas sensor according to each of the embodiments previously described is applied to an exhaust gas purifying system equipped with one or more DPF (diesel particulate filter) mounted on motor vehicles. The concept of the present invention is not limited by this. It is possible to apply the gas sensor according to the present invention to a gas purifying system mounted on a large scaled plant such as a thermal power station which is a power plant in which the prime mover is steam driven.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A gas sensor capable of detecting a concentration of conductive fine particles contained in a target detection gas by detecting a resistance value of detection parts, the resistance value of the detection parts being changed on the basis of a quantity of the conductive fine particles captured by and accumulated on the detection parts, the gas sensor comprising:
a heat resistance substrate; and
a plurality of detection parts, formed on a surface of the heat resistance substrate, having a different detection range and a part of which is overlapped to each other.

2. The gas sensor according to claim 1, wherein the detection parts are composed of a first detection part and a second detection part, and a detection range of the second detection part is within a range of 1/10 to ½ times of a detection range of the first detection part.

3. The gas sensor according to claim 1, wherein the first detection part is comprised of one or more pairs of detection electrodes which are formed on the heat resistance substrate, each pair of the detection electrodes faces to each other and are arranged at a first gap, and the second detection part is comprised of one or more pairs of detection electrodes which are formed on the heat resistance substrate, each pair of the detection electrodes faces to each other and are arranged at a second gap, and the second gap is within a range of 1/10 to ½ times of the first gap.

4. The gas sensor according to claim 1, wherein at least the second detection part in the first detection electrode and the second detection electrode is comprised of detection electrodes and a porous conductive layer having a predetermined porosity formed on the heat resistance substrate.

5. The gas sensor according to claim 1, wherein the first detection part and the second detection part are placed at an upper side and a bottom side of the gas sensor along a longitudinal direction of the gas sensor so that the second detection part is arranged at a high temperature side when the gas sensor is placed in a target detection gas to be detected.

6. The gas sensor according to claim 1, wherein the gas sensor detects a concentration of a target detection gas emitted from an internal combustion engine and flows in an exhaust gas system of the internal combustion engine.

7. The gas sensor according to claim 1, wherein the first detection part is placed between an electric power source and a first detection resistance, and a change of the resistance value of the first detection part is detected through the voltage of the first detection resistance, and
the second detection part is placed between the electric power source and a second detection resistance, and a change of the resistance value of the first detection part is detected through the voltage of the second detection resistance.

8. The gas sensor according to claim 1, wherein the first detection part is placed between an electric power source and a first operational amplifier connected to a first constant current power source, and a change of the resistance value of the first detection part is detected through the first operational amplifier, and
the second detection part is placed between the electric power source and a second operational amplifier connected to a second constant current power source, and a change of the resistance value of the first detection part is detected through the second operational amplifier.

9. The gas sensor according to claim 6, wherein the internal combustion engine is one of a diesel engine, a gasoline engine, a gasoline direct injection engine.
